(19) United States
(12) Patent Application Publication
(10) Pub. No.: US 2015/0134352 A1
(43) Pub. Date: May 14, 2015

(54) DIGITAL PEN SYSTEM FOR RECORDING MEDICAL INFORMATION

(71) Applicant: QSI MANAGEMENT, LLC, Irvine, CA (US)

(72) Inventors: Craig Strickland, Ann Arbor, MI (US); Roy William Feague, Scotts Valley, CA (US); Nicholas John Farrell, Oakland, CA (US)

(21) Appl. No.: 14/537,766

(22) Filed: Nov. 10, 2014

Related U.S. Application Data
(60) Provisional application No. 61/901,665, filed on Nov. 8, 2013.

(51) Int. Cl. G06F 19/00

(52) U.S. Cl. CPC G06F 19/3487
USPC 705/2

(57) ABSTRACT

Systems and methods of capturing responses to question prompts using a smart pen and special paper. The smart pen has sensors to collect data about its user, such as temperature, moisture, motion, and magnetism. The smart pen can also detect features of the special paper to determine a location on the paper such that responses to prompts can be correlated with the prompts by location on the page. Responses can be captured as handwriting or as audio, and all sensor information collected during the course of a response can be used to further analyze that response.

This application claims priority to U.S. Provisional Patent Application Ser. No. 61/901,665, filed Nov. 8, 2013. All extrinsic materials identified herein are incorporated by reference in their entirety.

### FIELD OF THE INVENTION

The field of the invention is medical information collection system.

### BACKGROUND

The background description includes information that may be useful in understanding the present invention. It is not an admission that any of the information provided in this application is prior art or relevant to the presently claimed invention, or that any publication specifically or implicitly referenced is prior art.

Electronic healthcare record systems struggle to balance between the need for highly structured data (which is easy to process) and narrative data (which includes more detail and nuance). Government regulations such as HITECH have created a demand that healthcare providers document patient encounters using electronic records systems that must capture highly discrete and reportable data elements. An example of these reportable data elements includes details of a patient's smoking history. It is not sufficient that this information is captured in a paragraph of text or in a recording of an audio presentation of the information (e.g., recording the patient's verbally describing the smoking history). The data must be available in a reportable, structured form such that the data can be retrieved and compared against effortlessly.

In healthcare, it is important for data to be highly structured. It is no longer sufficient to have an unstructured paragraph of text that is the “assessment”; instead, each individual diagnosis or Review of Systems point must be identified in separate fields. Efforts have been made to automate the creation of this structure using Natural Language Processing technology, but results are still coarse and error prone.

In almost every industry, there is some need to capture electronic data from users. Historically such data capture has been accomplished primarily via keyboard, but in recognition of the fact that people also communicate with voice and handwriting, significant effort has gone into the creation of systems to capture and recognize these forms of communication as well.

Anoto digital pens such as the DP-201 capture handwriting, handwriting recognition software such as VisionObjects' MyScript converts it to text. Voice recognition software such as Dragon Naturally Speaking work with live microphones or voice recorders.

With the invention of the LiveScribe digital pen (U.S. Pat. No. 8,446,297 to Marggraff et al. entitled “Grouping Variable Media Inputs to Reflect a User Session,” filed Mar. 31, 2009), handwriting and voice recording were integrated into a single device. This enabled workflow involved starting a voice recording by touching a designated control area on a page, and then making further marks (or gestures using the digital pen) on the page during the recording. Using an internal clock in the device, such gestures are associated temporally with the point in the audio recording corresponding to the time when the gesture was made. Playback of the recorded audio can then be controlled by tapping a mark on the page, causing the pen to begin playback at the associated point in the recorded audio.

This was a significant improvement in the convenience and intuitiveness of voice and handwriting capture, but the output was still unsuitable for most business applications because it was insufficiently granular.

Thus, there is still a need to improve on existing data collection system for medical providers.

All publications identified in this application are incorporated by reference to the same extent as if each individual publication or patent application were specifically and individually indicated to be incorporated by reference. Where a definition or use of a term in an incorporated reference is inconsistent or contrary to the definition of that term provided in this application, the definition of that term provided in this application applies and the definition of that term in the reference does not apply.

### SUMMARY OF THE INVENTION

One aspect of the inventive subject matter involves a system for extracting structured data from raw data. The system for extracting structured data includes a database, a smart pen, and a server. The database stores data structures that include a plurality of data fields. The smart pen includes an audio recording device and an optical sensor. And the server, which is communicatively coupled with the smart pen and the database, is programmed to: (1) retrieve audio data and associated image data from the smart pen; (2) correspond the audio data with a first one of the plurality of data fields in the data structure based on the associated image data; and (3) store the audio data in the database as a new data entry for the first one of the plurality of data fields.

In preferred embodiments, the smart pen also includes a management module programmed to associate the audio data with the image data in response to a gesture input. This gesture input can be, for example, a double tap of the smart pen. In preferred embodiments, the image data comprises hand-writing notes made by a user of the smart pen. In even more preferred embodiments, the hand-writing notes are temporally synchronized with the audio data recorded while the hand-writing notes were made. The server could also be further programmed to derive a medical meaning based on an association between the hand-writing notes and the audio data.

In some embodiments, the smart pen is works with special paper imprinted with distinct micro-patterns at different locations on the paper. In this way, the image data collected by the smart pen includes a micro-pattern, where the micro pattern indicates a location on the special paper.

The database of preferred embodiments also stores associations between the distinct micro-patterns and the plurality of data fields. For example, different locations on the special paper are designated to be associated with different data fields.

One aspect of the inventive subject matter involves a system for extracting structured data from raw data. The system includes a database to store structured data according different fields, a server, and a smart pen. The smart pen can record audio data and it can also capture image data. A control application cooperates with the smart pen to: (i) record audio and optical data upon receiving an instruction from a user and (ii) transfer the recorded data to the server. That server can then: (i) extract field information from the recorded data; (ii) divide the recorded data into non-overlapping data groups; and (iii) associate one data group with one field and another data group with another field based on extracted field information.

In some embodiments, the smart pen can transfer recorded data to the server using a USB connection. The recorded data can include image data captured by the optical sensor, and the image data can include, for example, micro-pattern data and/or coordinate data.

Another aspect of the inventive subject matter involves a method for extracting structured data from raw data. The method for extracting structured data includes a six steps. (1) storing a data structure comprising a plurality of data fields to a database; (2) providing a smart pen that includes an audio recording device and an optical sensor; (3) coupling a server communicatively with the smart pen and the database; (4) retrieving, by the server, audio data and associated image data from the smart pen; (5) correlating, by the server, the audio data with a first one of the plurality of data fields in the data structure based on the associated image data; and (6) storing the audio data in the database as a new data entry for the first one of the plurality of data fields.

Various objects, features, aspects and advantages of the inventive subject matter will become more apparent from the following detailed description of preferred embodiments, along with the accompanying drawing figures in which like numerals represent like components.

### BRIEF DESCRIPTION OF THE FIGURES

FIG. 1 illustrates an example data extracting system of some embodiments.

FIGS. 2A-2B show examples of a patient intake form.

FIG. 3 illustrates a flow chart of extracting data according to the inventive subject matter of some embodiments.

FIG. 4 shows an example of a dot pattern that can be printed onto special paper.

FIG. 5 shows an example of QR codes used in conjunction with prompts on an intake form.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, a circuit-switched network, the Internet, LAN, WAN, VPN, or other type of network.

One should appreciate that the disclosed authentication system provides numerous advantageous technical effects. The system enables computing devices to exchange digital tokens in the form of highly complex digital image descriptors derived from digital image data. The digital tokens are exchanged over a network as part of an authentication handshake function. If the computing device determines that the image descriptors satisfy authentication criteria, then the devices are considered authenticated. Thus, multiple computing devices are able to establish trusted communication channels among each other.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints and open-ended ranges should be interpreted to include only commercially practical values. The recitation of ranges of values herein is merely intended to serve as a shorthand method of referring individually to each separate value falling within the range. Unless otherwise indicated herein, each individual value within a range is incorporated into the specification as if it were individually recited herein. Similarly, all lists of values should be considered as inclusive of intermediate values unless the context indicates the contrary.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used in the description herein and throughout the claims that follow, when a system, engine, or a module is described as configured to perform a set of functions, the meaning of “configured to” or “programmed to” is defined as one or more processors being programmed by a set of software instructions to perform the set of functions.

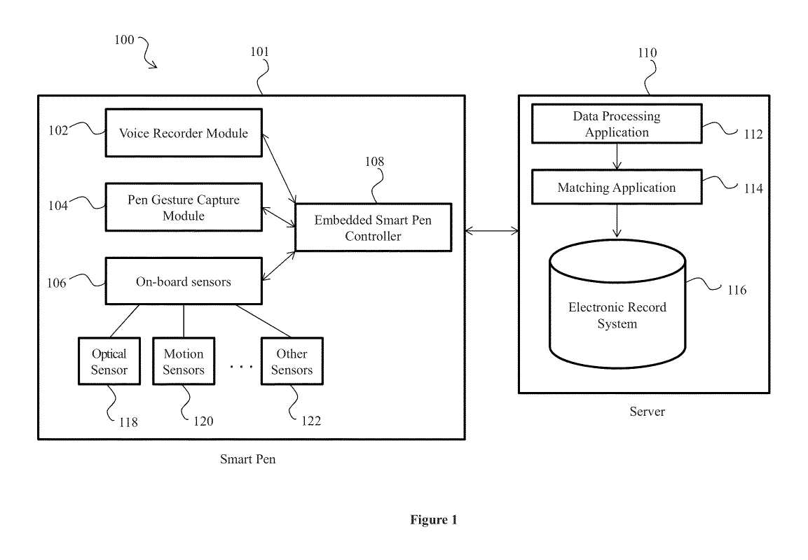

The inventive subject matter provides apparatuses, systems, and methods of extracting highly structured data based on raw data captured as optical data, motion data, or audio data (e.g., as voice and/or handwriting). FIG. 1 illustrates an example of such a data extracting system 100, which includes both a smart pen 101 and a server 110. The smart pen 101 is configured to receive input in a variety of modalities and from a voice recorder module 102, a pen gesture module 104, and a variety of on-board sensors 106.

The voice recorder module 102, the pen gesture capture module 104, and the on-board sensors 106 are configured to collect sensor information when the smart pen 101 is used. The voice recorder module 102 records audio after an activation event, and the pen gesture module 104 records motion-based gestures that a user made via the smart pen 101. The on-board sensors can include different types of sensors, such as an optical sensor 118 and a motion sensor 120. The optical sensor 118 of some embodiments can include a camera, an IR sensor, a laser sensor (e.g., a barcode reader), or any other optically-based sensor capable of detecting features of the special paper (e.g., micro-patterns) used with the smart pen and writings being made on the special paper. The motion sensor 120 of some embodiments can include an accelerometer, a gyroscope that can detect acceleration, velocity, and orientation of the smart pen 101. The other sensors 122 can preferably include sensors that can record pressure being applied to the smart pen 112, temperature, magnetic field strength and direction, and moisture. In some embodiments, voice recorder module 102, pen gesture capture module 104, and other on-board sensors 106 can be activated by tapping or double tapping the pen nib on a sheet of special paper. Once activated, the modules 102 and 104 and the on-board sensors 106 that are controlled by the embedded smart pen controller 108, can begin record sensor data. The embedded smart pen controller 108 records information from the modules and on-board sensors 102, 104, and 106, and stores that information temporarily on data storage (e.g., memory, hard drive, etc.) located within the smart pen 101 (not shown) before transmission to the server 110 (e.g., wirelessly, by USB, by SD card, or by any other technology currently known in the art).

Once the server receives information from the smart pen 101, a data processing application processes the raw information (e.g., optical data, audio data, motion data, temperature data, etc.). After the information is processed, the matching application 114 correlates the information gathered from the smart pen 101 with specific prompts or questions from, for example, an intake form. Finally, the information from the smart pen 101 that is now correlated with specific prompts or questions is saved to an electronic record system 116. The electronic record system 116 can be any database currently known in the art. This system can be integrally incorporated into the server, or it can be an external database that is communicatively coupled to the server. FIG. 1 shows the electronic record system 116 as a component of the server. Records created and stored facilitate easy access to information without requiring a scanner or hand-filing of records, and it also makes possible the addition of information beyond merely a response to a prompt by including sensor information or audio information.

In some embodiments, the smart pen 101 includes a voice recorder module 102 configured to receive audio input and a pen gesture capture module configured to capture gestures made with the pen. It also includes an optical sensor configured to capture and record ink strokes produced by a user writing with the smart pen as well as patterns (e.g., micro-patterns) that are printed on the instrument on which the user is writing with the smart pen. In some embodiments, the smart pen can determine a location of the pen by reading signals (e.g., electronic signals, micro-patterns, or signals from on-board sensors to determine position). In some embodiments, the smart pen is used on a special type of paper that is encoded with micro-patterns, where different locations on the paper express different micro-patterns that indicate different locations on the paper. When the smart pen is being placed and/or used on a particular location on the paper, the smart pen can determine its location by capturing and deciphering the pattern.

One example of a smart pen is the Livescribe Echo smart pen described in U.S. Pat. No. 8,446,297 to Marggraff et al. entitled “Grouping Variable Media Inputs to Reflect a User Session,” filed Mar. 31, 2009. The Marggraff et al. patent describes the functionalities of the smart pen, and it is incorporated by reference into this application. The smart pen can record the audio and/or replicate what the user of the smart pen has written on the special type of paper in the form of an image.

In some embodiments, the smart pen of the inventive subject matter is also loaded with a software program such as an embedded control application that cooperates with the voice recorder module, the pen gesture capture module, and the optical sensor to manage the collection of data. The software program or embedded control application can also cooperate with any other on-board sensors, such as an accelerometer, a velocity sensor, a position sensor, a gyro, a pressure sensor, a temperature sensor, a magnetometer, and a moisture sensor.

When the software program or embedded control application receives an indication (e.g., user double tapping on a pre-defined area of the special paper) that the user is providing raw data (e.g., voice or handwriting) associated with a particular pre-defined structured field, the software program or embedded control application is configured to begin recording the raw data using the voice recorder module (to record audio input) and/or the optical sensor (to record handwriting input). Upon receiving a stop signal (e.g., the user tapping on a particular area on the special paper, the user double tapping anywhere on the special paper, the user tapping outside of the special paper, etc.), the software program or embedded control application is configured to stop the recording and to encapsulate the recorded raw data that is associated with the particular pre-defined structured field in a self-contained data group. The software program or embedded control application is also configured to embed metadata that indicates the particular pre-defined field (e.g., coordinates of where the user taps on the special paper, the unique ID of the page that was tapped, etc.) within the data group.

Based on subsequent user's input, the software program or embedded control application can continue to record raw data that is associated with different pre-defined fields according to the method described above. When raw data is recorded for all of the pre-defined fields of a form (or alternatively the software program or embedded control application receives an end signal from the user based on a gesture), the software program or embedded control application is configured to create a single data package that stores the different groups of recorded raw data (e.g., handwriting data, audio data, etc.) along with the metadata.

The data package is transferred to the back-end server for processing when a connection link is established between the smart pen and the server (e.g., via Bluetooth®, WiFi, USB connection, etc.). In some embodiments, the server includes a data processing application that is configured to process the data collected by the smart pen. First, the data processing application is configured to associate each data group within the data package with the pre-defined field based on the metadata. For example, the coordinates of each double-tap event can be matched against the known layout of the form to determine the field on which the user tapped to start recording, and the unique ID of the form can be used to look up any needed associated metadata in a database of all printed forms, such as a patient ID.

If the received data includes any audio data (when the user has spoken the information into the pen), the data processing application can use a voice recognition software (such as Nuance Dragon Naturally Speaking or other transcription service) to obtain a transcription of the voice data. If the received data includes handwriting data (when the user has handwritten the information using the smart pen on the special paper), the data processing application can use a handwriting recognition software such as VisionObjects Myscript to obtain text data from the handwriting (which is usually in the form of an image). Since each group of the raw data is associated with a specific field of a form, the data processing application can insert the transcribed text data into the respective data field within the database.

Thus, by using the smart pen in concert with the special type of paper, the data extracting system allows the user to associate raw data (e.g., voice data captured by the audio recorder of the smart pen or handwriting data captured by the smart pen) with pre-determined fields by providing inputs to the pen before and/or after the user provides the raw data. For example, the user can indicate a first pre-defined field to the smart pen (e.g., by tapping the smart pen on a pre-defined area on the paper that is associated with the first field) before providing raw data (e.g., through voice or handwriting) that is associated with the first field. The user can then indicate a second pre-defined field to the smart pen (e.g., by tapping the smart pen on a pre-defined area on the paper that is associated with the second field) before providing raw data (e.g., through voice or handwriting) that is associated with the second field.

If the user writes in the field, the captured ink strokes are converted to text and the resulting text is assigned to the indicated field in the record. If the user dictates, the recorded audio is then automatically associated with the field which was tapped to start the recording. The audio is further converted to text using either an automated “speech-to-text” system or a human transcriptionist, and the resulting text is automatically entered into the desired field. The result is that the user obtains a textual result for the desired field, irrespective of the mode of communication (voice of writing) used.

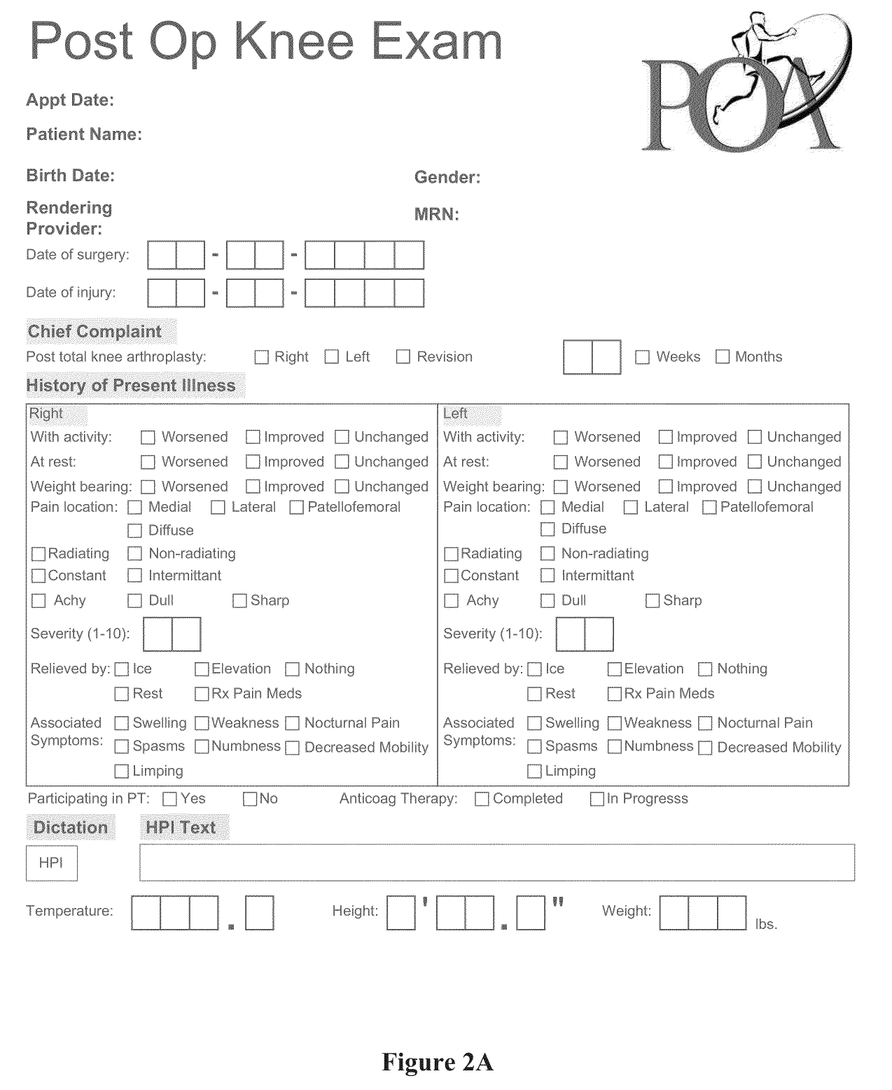

As an example, a physician might wish to document a patient encounter, capturing data using a form that looks similar to that shown in FIGS. 2A and 2B. The form can be presented on the special kind of paper as described above to work with a smart pen. Each given field within the form (e.g., History of Present Illness, Chief Complaint, etc.) is provided with a pre-defined area on the special paper. Thus, for any given field, the physician may choose to hand-write text in the pre-defined area that is associated with the field (in which case the smart pen will record the handwriting and associate the handwriting with the field), or instead may double-tap the smart pen on the pre-defined area associated with the field and dictate the desired content (in which case the smart pen will record the audio and associate the recorded audio with the field).The physician can then indicate the end of the raw data for that field by for example, tapping anywhere on the page.

The systems and methods described in this application can be broken down into different steps and different components. Although many components are at play during the intake process, the most important components for purposes of the inventive subject matter are the smart pen, the special paper, and the server.

The smart pen is first provided to a user along with a form printed onto special paper. The special paper includes distinct codes (e.g., micro dot patterns, QR codes, barcodes, magnetic or ferrous ink printed into a particular pattern, Arabic numerals or other plain text, etc.) such that different unique codes are printed on different locations on the special paper. Thus, the different unique codes can be associated with the different locations on the paper. Prompts for information are printed on the special paper with corresponding space for a response from the user.

To begin responding to a prompt on the form, the user can activate the smart pen by performing an action with the smart pen (e.g., double-tapping the tip of the smart pen onto the special paper, etc.). Once the smart pen 101 is activated, the controller 108 detects its relative location on the piece of special paper by detecting a unique code on the special paper via its optical sensor 118. When a sensor on the smart pen detects the unique code, the subsequent response is flagged as corresponding to the prompt that is printed at a location on the special paper at or near that unique code. The controller 108 of the smart pen 101 then instructs the voice recorder module 102 and the on-board sensors to being record audio, handwriting, or other data. This system provides advantages over existing systems in that is gives users a choice in how to respond to a prompt (i.e., by writing it down or by speaking a response, or both).

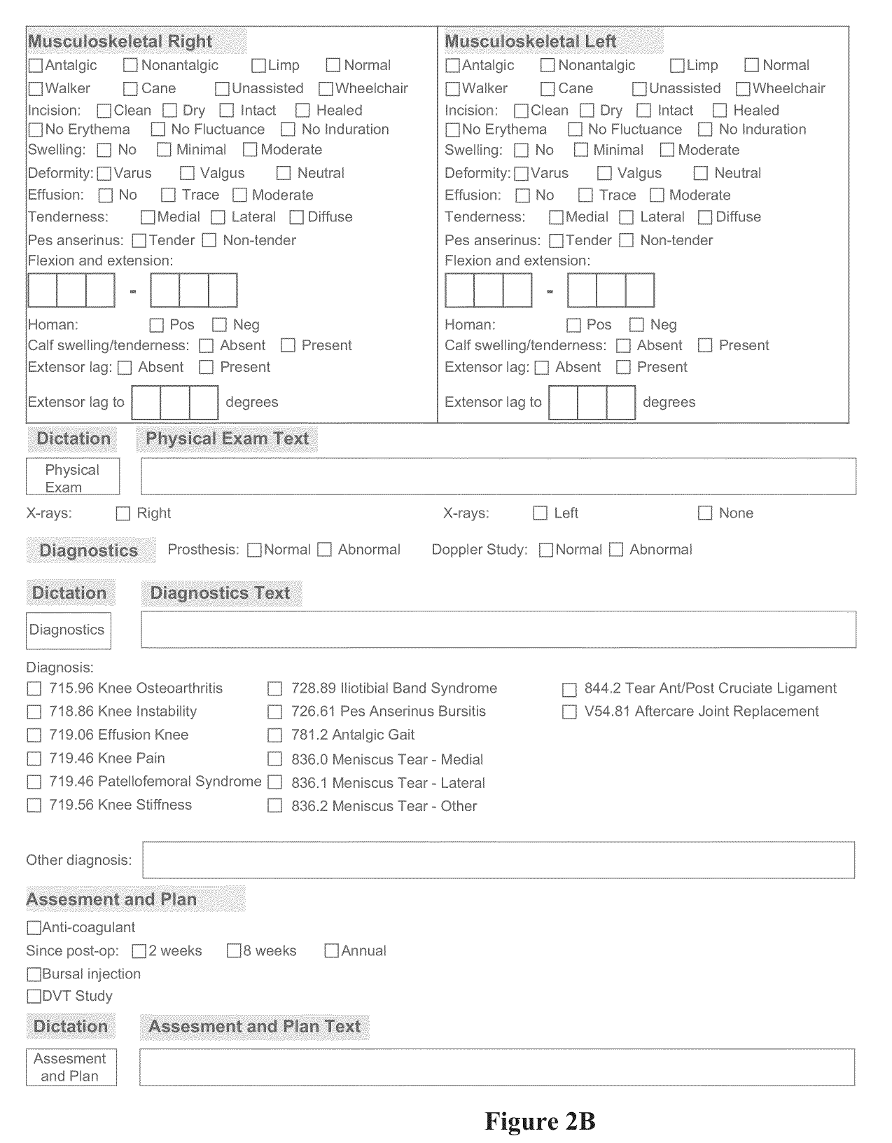

FIG. 3 shows a flow chart of one possible way to implement data management for this type of system. The smart pen 101 can have an interface (e.g., a USB interface) for communicating with the server 110. When the controller 108 receives optical data (e.g., handwriting information) and audio data (e.g., user's oral input) from the optical sensor 118 and the voice recorder module 102, respective, the controller 108 assigns timestamps to both the optical data and audio data, such that the data can be synchronized subsequently. Similarly, the controller 108 can assign the timestamps to other sensor data (e.g., motion data, temperature data, etc.) so that they can be synchronized with the optical data and audio data as well. The controller 108 of the smart pen 101 is configured to transmit the timestamped sensor data to the server 110 for further processing.

Upon receiving the sensor data, the server 110 can perform different preliminary processing to the data. For example, the data processing application 112 of the server 110 can use a handwriting recognition module to translate the handwriting into text. In addition, the data processing application 112 of the server 110 can use a voice recognition module to translate the audio data into text. So when a user writes a response into a form, the handwriting can be recognized and the response converted into a font-based format. Moreover, when a user speaks and the smart pen records the user's voice, that speech can be converted into a response and correlated with a particular prompt (e.g., by initiating the response with a double tap in a particular location, as discussed above in more detail). Then, the matching application 114 is configured to match different portions of the optical data, audio data, and other sensor data to different entries (e.g., data fields) of the form based on the code detected by the smart pen 101. The server 110 is configured to store the matched data in the electronic record system 116 according to their matched data fields.

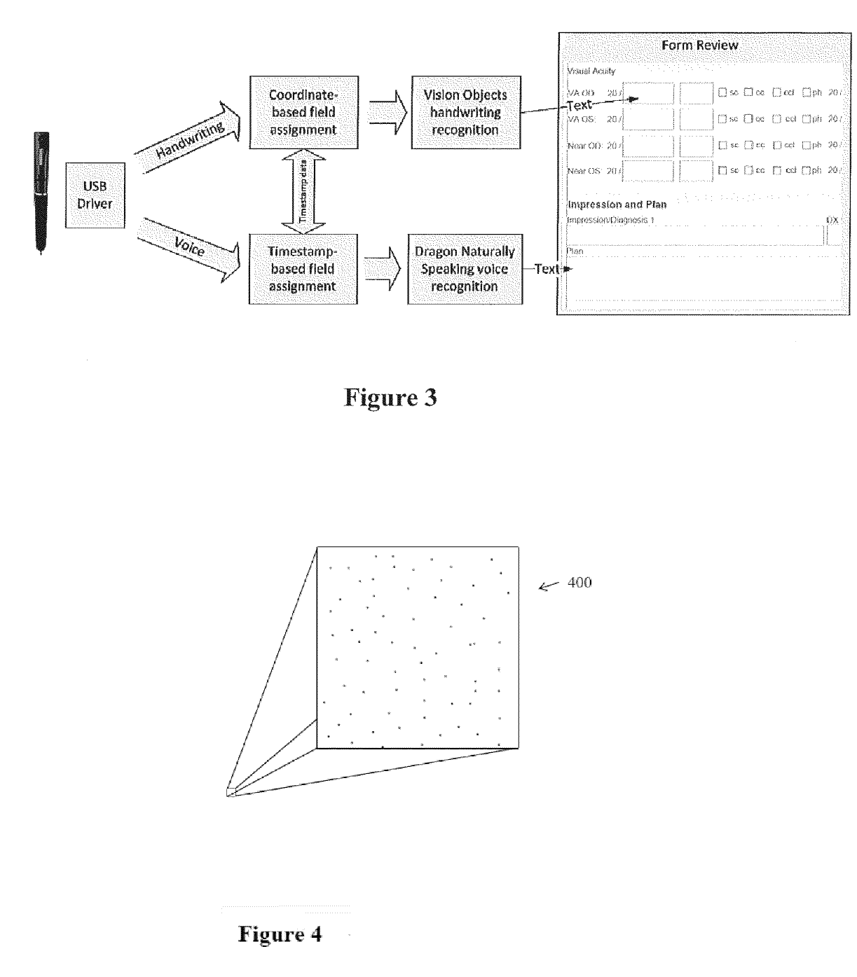

As shown in FIG. 4, the unique codes can be a feature of the special paper that correlates to a location. The special paper could have patterns printed onto it where the patterns are unique at every location on the paper (as discussed with regard to FIGS. 2A and 2B). FIG. 4 in particular shows an example of a dot pattern 400 indicating coordinates on a piece of paper, such that any portion of the special paper has a corresponding dot pattern indicative of, for example, X and Y coordinate (or alternatively, cylindrical coordinates or any other coordinate system). The dot pattern could be printed very small (e.g., micro-scale) and with different colors to make the pattern more discrete. In some embodiments, the pattern could be printed with magnetic or ferrous ink that takes the same color as the special paper. In this way, the special paper could appear identical to any other sheet of paper, but the smart pen would be capable of detecting the pattern. Thus, no matter where the smart pen is used on the paper, the optical sensor on the smart pen will be able to correlate a paper location with the subsequent input.

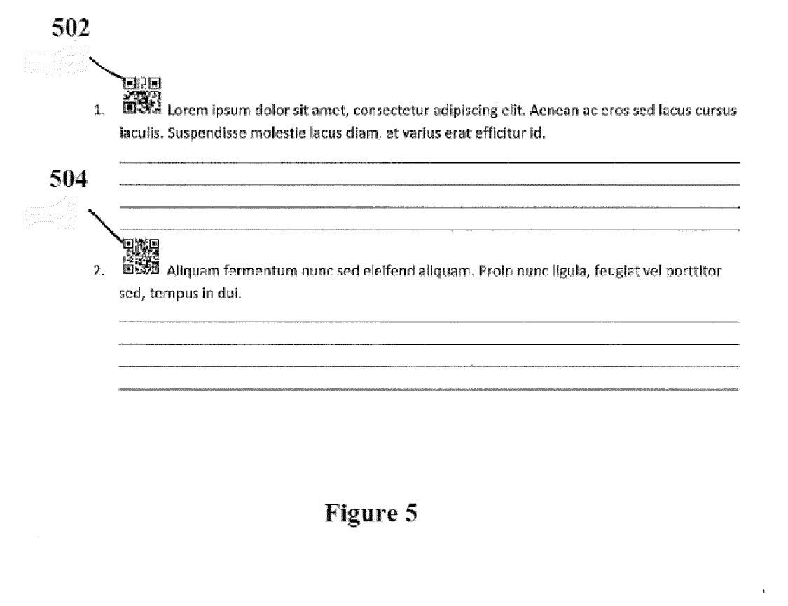

Alternatively, as shown in FIG. 5, the unique codes 502 and 504 (pictured as QR codes) used to indicate initiation and location of a response can be codes specifically correlated with a prompt (e.g., QR codes, barcodes, magnetic or ferrous ink, or even just an Arabic numeral or other plain text). Regardless of the implementation elected, the unique code or the special paper contain information indicating coordinates on the special paper, which allows for correlating a patient's response with a position on a paper.

In addition to collecting a written or spoken response from a patient, the smart pen can collect other information about the patient and the patient's physiological responses to certain prompts. To do this, the smart pen could include an accelerometer, a gyroscope, a velocity sensor, a position sensor, a temperature sensor, a moisture sensor, a conductivity sensor, and/or a magnetometer. Each of these sensors can collect different information about a patient during the process of responding to a prompt. For example, an accelerometer, gyroscope, velocity sensor, and position sensor can detect whether a person is trembling. A temperature sensor can detect whether a person's hand suddenly changes temperature. A conductivity sensor can detect changes in conductivity brought on by, for example, changes in moisture, which indicates a person sweating when answering particular questions.

For example, if a person filling out an intake form reads a prompt asking, “Have you had unprotected sex with a person you know to have HIV?” then the smart pen might detect a change in moisture or temperature of the patient's hand, or even notice that the person begins trembling. These clues could help cue in doctors and healthcare providers to issues that they otherwise might not be aware of in the first place.

Responses recorded by the smart pen are transmitted from the smart pen to a server. The server, which contains information correlating each unique code with a particular question on the patient intake form printed on the special paper, enables doctors and healthcare organizations conducting the intake to digitally receive and review the patient's responses to each question posed. Once data is collected from the smart pent, the server could automatically superimpose the patient's writing onto a digital copy of the form.

In embodiments where the smart pen detects location by optical cues on the special paper itself (e.g., patterns printed onto the paper that indicate location), the written response and corresponding location information is recorded and transmitted from the smart pen to a server. Transmission can be accomplished by USB, SD card (micro, standard, or otherwise), wireless (WiFi, Bluetooth, NFC, etc.), wired, or any other method of transmission known in the art. Location information can be interpreted by the smart pen so that location coordinates are transmitted, or the raw optical information from the smart pen can be sent to the server so that the server can deduce location information. The server can then use the location information to superimpose each response onto a template of the intake forms having each prompt, thus creating a digital copy of the intake form without requiring a user to physically scan any documents. As also discussed above, the smart pen could additionally collect information from its on-board sensors to transmit with the response information.

In addition to superimposing the patient's writing, the digital copy of the form could also incorporate information about the patient's physiological responses. In other words, a digital copy of the form that includes the patient's response could provide an interface to make the data collected by the on-board sensors accessible (e.g., if a user taps, clicks, or otherwise indicates interest in a particular response, all sensor data for that prompt/response combination could be presented to the user).

After a patient has completed an intake form, the smart pen has collected data from its sensors that needs to be offloaded to the server to be analyzed and used. To accomplish this, a user connects the pen to a computer and the data is loaded from the smart pen to the computer, and data from the smart pen is loaded to the computer (e.g., into a *.zip file). The patient's pen strokes and writing is grouped by page, and the information is then transmitted to the server (e.g., via HTTP POST). Once the server receives the information, it identifies the types of data present in the data (e.g., writing data, audio data, and other sensor data from the sensors described above).

As an example of the concepts discussed above, a patient intake form could include many different fields that need to be filled out to provide a doctor (or any other entity conducting a patient intake) with sufficient information to begin helping a patient. To make the intake process easier, the patient could be provided with a smart pen as described above and special paper for use with the smart pen. The special paper can include prompts and space for the patient to write. Before answering a question, the patient could press the pen into a box or a region where they are supposed to write their answer, and the pen would correlate any input that follows with the question being posed by the prompt associated with that region of the special paper. In addition, based on where the pen is pressed onto the special paper, the smart pen could either activate an audio sensor to allow the patient to answer the prompt orally. But it could also activate its optical or motion-related sensors to detect what the patient writes into the response space. This provides advantages over the prior art in that it gives the smart pen user a choice as to whether he wishes to record audio or record handwriting (e.g., if a person is uncomfortable responding out loud to some questions, but doesn't mind for others). This system provides patients with two options for inputting data during patient intake, and it allows the organization conducting the intake to quickly receive the information in a digital format (e.g., via the pen itself, transferred to a server).

In yet another example, a smart pen can be used with special paper to conduct a patient intake, but, as discussed above, it can collect information beyond simply the patient's responses. Using a variety of sensors included in the smart pen (e.g., an accelerometer, a gyroscope, a velocity sensor, a position sensor, a temperature sensor, a moisture sensor, and/or a magnetometer), certain physiological information about a patient can also be collected while the patient is filling out forms. For example, while using the smart pen, the moisture of a patient's hands can be measured using a moisture sensor, the temperature of the patient's skin can be measured using a temperature sensor, the amount a patient's hand shakes while writing responses can be measured using an accelerometer (or using some combination of an accelerometer, a velocity sensor, a position sensor, and a gyroscope), whether a person's hand tends to shake in a given direction can be measured using an accelerometer (or using some combination of an accelerometer, a velocity sensor, a position sensor, and a gyroscope). In addition, rotational movement of a smart pen can be detected using a gyroscope and/or an accelerometer. This information can be used to alert doctors to various possible medical conditions suffered by the patient.

In the example above, the special paper can include prompts with space for a patient to provide a response. Before providing a response a patient presses the smart pen into a particular region of the paper (e.g., pressing the smart pen onto a unique code or having the smart pen detect location based on the pattern pre-printed onto the special paper), which correlates the response that follows with the correct prompt. Then, while providing a written or oral response, the smart pen could collect sensor information. Information collected can include temperatures, movements, rotations, moisture levels, and other physiological responses. By examining how sensor information changes with time based on the prompt the patient responds to, the organization conducting the intake can gain a better understanding of the patient's concerns and potential medical problems.

It should be apparent to those skilled in the art that many more modifications besides those already described are possible without departing from the inventive concepts in this application. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for extracting structured data, the system comprising:
a database configured to store a data structure comprising a plurality of data fields;
a smart pen comprising an audio recording device and an optical sensor; and
a server communicatively coupled with the smart pen and the database, and programmed to:
retrieve audio data and associated image data from the smart pen,
correspond the audio data with a first one of the plurality of data fields in the data structure based on the associated image data, and
store the audio data in the database as a new data entry for the first one of the plurality of data fields.

2. The system of claim 1, wherein the smart pen further comprises a management module programmed to associate the audio data with the image data in response to a gesture input.

3. The system of claim 2, wherein the gesture input comprises a double tap of the smart pen.

4. The system of claim 1, wherein the smart pen is configured to work with a special paper imprinted with distinct micro-patterns at different locations on the paper.

5. The system of claim 4, wherein the image data comprises a micro-pattern.

6. The system of claim 4, wherein the database is further configured to store associations between the distinct micro-patterns and the plurality of data fields.

7. The system of claim 4, wherein different locations on the special paper are designated to be associated with different data fields in the plurality of data fields.

8. The system of claim 1, wherein the image data comprises hand-writing notes made by a user of the smart pen.

9. The system of claim 8, wherein the hand-writing notes are temporally synchronized with the audio data recorded while the hand-writing notes were made

10. The system of claim 8, wherein the server is further programmed to derive a medical meaning based on an association between the hand-writing notes and the audio data.

11. A method of extracting structured data, comprising:
storing a data structure comprising a plurality of data fields to a database;
providing a smart pen comprising an audio recording device and an optical sensor;
coupling a server communicatively with the smart pen and the database;
retrieving, by the server, audio data and associated image data from the smart pen,
correlating, by the server, the audio data with a first one of the plurality of data fields in the data structure based on the associated image data; and
storing the audio data in the database as a new data entry for the first one of the plurality of data fields.

12. The method of claim 10, wherein the smart pen further comprises a management module programmed to associate the audio data with the image data in response to a gesture input.

13. The method of claim 12, wherein the gesture input comprises a double tap of the smart pen.

14. The method of claim 11, wherein the smart pen is configured to work with a special paper imprinted with distinct micro-patterns at different locations on the paper.

15. The method of claim 14, wherein the image data comprises a micro-pattern.

16. The method of claim 14, wherein the database is further configured to store associations between the distinct micro-patterns and the plurality of data fields.

17. The method of claim 14, wherein different locations on the special paper are designated to be associated with different data fields in the plurality of data fields.

18. The method of claim 11, wherein the image data comprises hand-writing notes made by a user of the smart pen.

19. The method of claim 18, wherein the hand-writing notes are temporally synchronized with the audio data recorded while the hand-writing notes were made.

20. The method of claim 18, wherein the server derives a medical meaning based on an association between the hand-writing notes and the audio data.
